(19) United States
(12) Patent Application Publication
(10) Pub. No.: US 2026/0193068 A1
(43) Pub. Date: Jul. 9, 2026

(54) TILT CONTROL SYSTEM OF FORKLIFT

(71) Applicant: DOOSAN BOBCAT KOREA CO., LTD., Incheon (KR)

(72) Inventors: Beomkyun YU, Incheon (KR); Yongmin SEO, Incheon (KR)

(73) Assignee: DOOSAN BOBCAT KOREA CO., LTD., Incheon (KR)

(21) Appl. No.: 19/209,951

(22) Filed: May 16, 2025

(30) Foreign Application Priority Data
Jan. 6, 2025 (KR) 10-2025-0001657

(51) Int. Cl. B66F 9/22; B66F 9/08

(52) U.S. Cl. CPC B66F 9/22; B66F 9/082

(57) ABSTRACT

A tilt control system of a forklift includes a main hydraulic line, which includes a tilt cylinder configured to tilt a mast forward or backward, and a direction control valve configured to control a tilt direction of the mast, and a pilot hydraulic line, which includes a remote control valve connected to the direction control valve and configured to control the direction control valve, and a pressure reducing valve provided between the direction control valve and the remote control valve, wherein the pressure reducing valve includes a push rod configured to be displaced by one end being pressed or released by the tilt cylinder, the pressure reducing valve configured to reduce pressure at a rear end of the pressure reducing valve on the pilot hydraulic line according to a displacement of the push rod when a tilt angle of the mast exceeds or is less than a preset angle range.

### CROSS-REFERENCE TO RELATED APPLICATION(S)

This application is based on and claims priority under 35 U.S.C. § 119 to Korean Patent Application No. 10-2025-0001657, filed on Jan. 6, 2025, in the Korean Intellectual Property Office, the disclosure of which is incorporated by reference herein in its entirety.

### BACKGROUND

### 1. Field

The disclosure relates to a tilt control system of a forklift, and more particularly, to a tilt control system of a forklift capable of reducing shock by decelerating a piston when a stroke of the piston approaches an end inside a tilt cylinder that tilts a mast.

### 2. Description of the Related Art

A forklift is an industrial vehicle used to lift and transport cargo, and is used to load, transport, and unload cargo in warehouses, logistics centers, ports, etc. In general, a forklift consists of a fork for loading cargo and a mast for lifting the loaded cargo.

The mast of the forklift performs the role of lifting and lowering cargo. The mast is equipped with the fork, and after loading cargo onto the fork, the mast lifts the cargo to move the cargo vertically or load the cargo to a desired height. Meanwhile, to ensure work stability and increase efficiency, the mast of the forklift can be tilted forward and backward.

More specifically, when the mast is tilted backward after loading cargo, the center of gravity moves toward the forklift, which reduces the risk of flipping over and more stably fixes pallets. Then, tilting the mast forward makes it easier to insert and remove the pallets, thereby improving the efficiency of loading and unloading.

The tilt function of the mast is implemented by a hydraulic actuator called a tilt cylinder, and when the tilt cylinder is tensioned or compressed, the mast can be tilted forward or backward. When a stroke of a piston reaches an end inside the tilt cylinder, the piston stops suddenly, which causes shock.

In order to absorb or mitigate such shock, conventionally, a shock absorbing device such as a rubber pad has been installed at the end of the piston, or a device for controlling fluid flow has been additionally installed at the end of the cylinder to smoothly stop the piston. However, these methods have the problem of parts replacement due to durability and are difficult to apply when precise synchronization of multiple tilt cylinders is required.

Accordingly, a shock mitigation method capable of improving durability and synchronizing the operations of multiple tilt cylinders is required.

### SUMMARY

An embodiment provides a tilt control system of a forklift capable of decelerating an operation of a tilt cylinder when the operation of the tilt cylinder reaches an end by linking the operation of the tilt cylinder with a pressure reducing valve of a pilot hydraulic circuit, thereby mitigating shock and reducing an operator's working fatigue.

An embodiment provides a tilt control system of a forklift capable of reducing system costs and improving durability through a simple structure using a pressure reducing valve.

An embodiment provides a tilt control system of a forklift capable of limiting an operating range of a tilt cylinder by adjusting an operating point of a pressure reducing valve without adding another component to the tilt cylinder.

An embodiment provides a tilt control system of a forklift capable of easily synchronizing operations of a plurality of tilt cylinders.

Additional aspects of the disclosure will be set forth in part in the description which follows and, in part, will be obvious from the description, or may be learned by practice of the disclosure.

In accordance with an aspect of the disclosure, a tilt control system of a forklift may include: a main hydraulic line including a tilt cylinder configured to tilt a mast forward or backward, a first hydraulic pump configured to supply a working fluid to the tilt cylinder, and a direction control valve configured to control a tilt direction of the mast; and a pilot hydraulic line including a second hydraulic pump configured to supply a control fluid, a remote control valve connected to the direction control valve and configured to control the direction control valve, and a pressure reducing valve provided between the direction control valve and the remote control valve, wherein the pressure reducing valve includes a push rod configured to be displaced by one end being pressed or released by the tilt cylinder, the pressure reducing valve configured to reduce pressure of the control fluid at a rear end of the pressure reducing valve on the pilot hydraulic line according to a displacement of the push rod when a tilt angle of the mast exceeds or is less than a preset angle range.

The direction control valve may include an inlet through which the working fluid is supplied to the direction control valve, an outlet through which the working fluid is discharged from the direction control valve, a main spool configured to operate by hydraulic pressure of the control fluid, and a flow path connecting the inlet to the outlet.

The direction control valve may be configured to reduce an opening area of the flow facing at least one of the inlet and the outlet when the pressure of the control fluid at the rear end of the pressure reducing valve on the pilot hydraulic line is reduced.

The pressure reducing valve may include a housing being a hollow type and including a plurality of ports, and a pilot spool of which one side is connected to another end of the push rod, the pilot spool configured to be slidable inside the housing.

The plurality of ports may include a first port configured to receive the control fluid from the second hydraulic pump, a second port configured to discharge the control fluid to the direction control valve, and a third port connected to an oil tank.

The pilot spool may connect the first port to the second port at a first position and connect the second port to the third port at a second position.

When a tilt angle of the mast belongs to the preset angle range, the pilot spool may be located at the first position, and when a tilt angle of the mast exceeds or is less than the preset angle range and the push rod is displaced by a preset distance, the pilot spool may slide and be located at the second position.

The pilot spool may be in a cylinder shape and include a groove recessed from an outer surface of the pilot spool and configured to selectively connect the second port to one of the first port and the third port.

The push rod, the other end of which may be inserted into the housing, may be configured to move inward or outward relative to the housing, wherein another end of the push rod is inserted into the housing, and the pressure reducing valve may include an elastic member of which one side is connected to the push rod and another side is connected to the pilot spool.

The tilt control system may further include a mounting bracket of which one side is coupled to a body of the forklift, wherein the housing may be mounted on another side of the mounting bracket.

The tilt cylinder may be rotatable relative to the body on a rotation axis of one side, the tilt cylinder further including a pressing member extending parallel to the rotation axis, wherein one side of the pressing member may be provided in the tilt cylinder to rotate together with the tilt cylinder, and another side of the pressing member may be configured to press the push rod according to a rotation of the tilt cylinder.

The tilt control system may further include a motion converting mechanism configured to couple the pressing member to the push rod and convert a rotational motion of the pressing member into a linear motion of the push rod.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a circuit diagram schematically showing a tilt control system of a forklift according to an embodiment;

FIG. 2 is a circuit diagram showing a case in which a mast shown in FIG. 1 is tilted backward;

FIG. 3 is a circuit diagram showing a case in which a tilt angle of the mast shown in FIG. 1 is less than a preset angle range while the mast is tilted backward;

FIG. 4 is a circuit diagram showing a case in which the mast shown in FIG. 1 is tilted forward;

FIG. 5 is a circuit diagram showing a case in which a tilt angle of the mast shown in FIG. 1 exceeds a preset angle range while the mast is tilted forward;

FIG. 6 is a perspective view and an enlarged view showing a main part of a tilt control system of a forklift according to an embodiment;

FIG. 7 is a cross-sectional view showing a first pressure reducing valve which is a main part of a tilt control system of a forklift according to an embodiment;

FIG. 8 is a cross-sectional view showing a second pressure reducing valve of a tilt control system of a forklift according to an embodiment;

FIG. 9 is a cross-sectional view of a main part of a tilt control system of a forklift according to an embodiment, additionally showing a motion converting mechanism; and

FIG. 10 is an enlarged perspective view of a main part of a tilt control system of a forklift according to an embodiment, additionally showing a motion converting mechanism.

### DETAILED DESCRIPTION

Hereinafter, embodiments will be described in detail with reference to the accompanying drawings. The following embodiments are provided to sufficiently transfer the concepts of the disclosure to one of ordinary skill in the technical art to which the disclosure belongs. However, the disclosure is not limited to these embodiments, and may be embodied in another form. In the drawings, parts that are irrelevant to the descriptions may not be shown in order to clarify the disclosure, and also, for easy understanding, the sizes of components are more or less exaggeratedly shown.

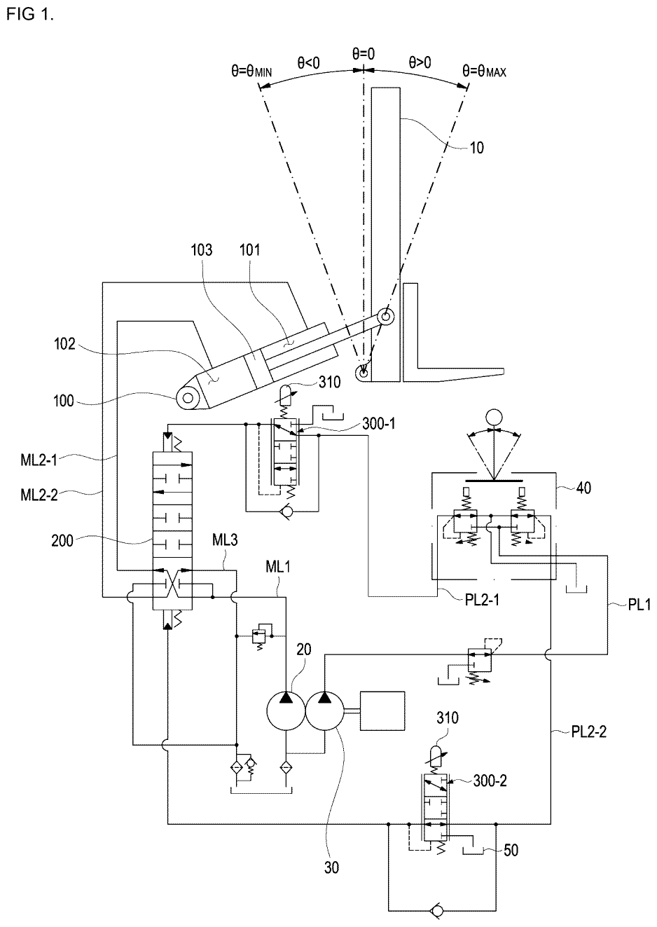

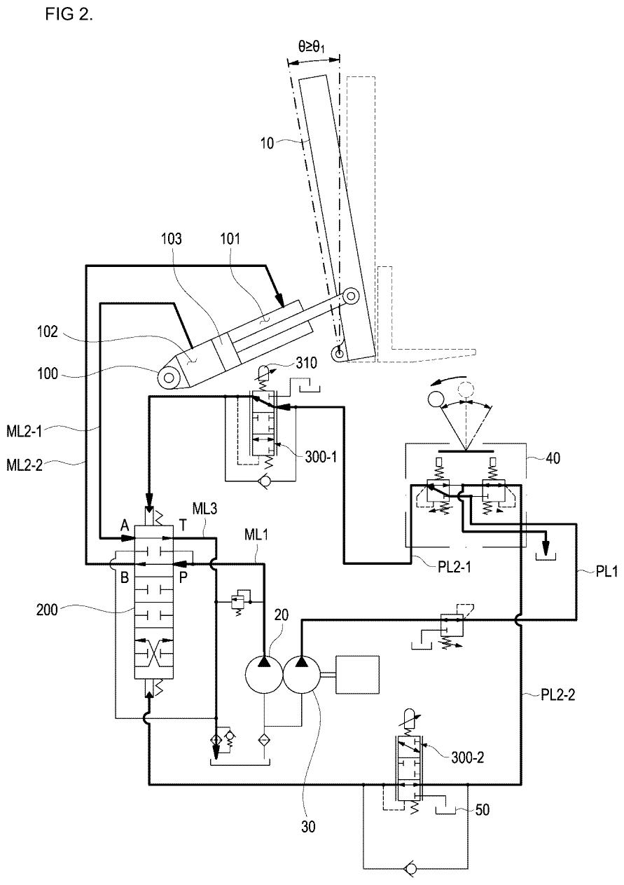

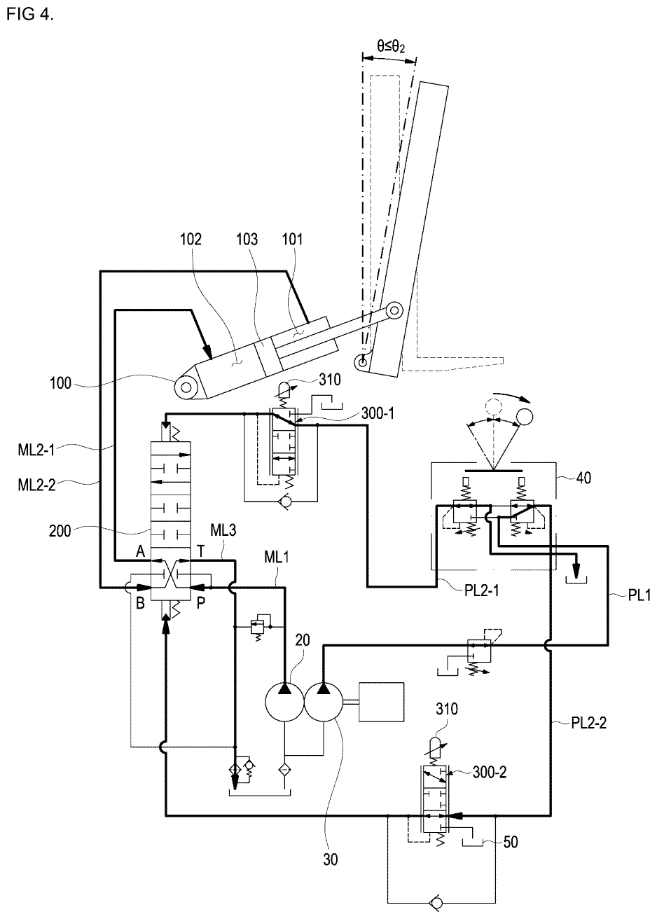

FIGS. 1, 2, and 4 are circuit diagrams, wherein FIG. 1 schematically shows a tilt control system of a forklift according to an embodiment, FIG. 2 shows a case in which a mast 10 shown in FIG. 1 is tilted backward, and FIG. 4 shows a case in which the mast 10 shown in FIG. 1 is tilted forward.

Referring to FIGS. 1, 2, and 4, a tilt control system of a forklift according to an embodiment may include: a main hydraulic line ML including a tilt cylinder 100 that tilts the mast 10 forward or backward, a first hydraulic pump 20 that supplies a working fluid to the tilt cylinder 100, and a direction control valve 200 that controls a tilt direction of the mast 10; and a pilot hydraulic line PL including a second hydraulic pump 30 that supplies a control fluid, a remote control valve 40 connected to the direction control valve 200 to control the direction control valve 200, and a pressure reducing valve 300 positioned between the direction control valve 200 and the remote control valve 40.

The mast 10 may be tilted forward (right direction in FIG. 1) or backward (left direction in FIG. 1), and the tilting may be performed by the tilt cylinder 100.

The first hydraulic pump 20 may press the working fluid and send the working fluid to the main hydraulic line ML, and the second hydraulic pump 30 may press the working fluid and send the working fluid to the pilot hydraulic line PL. The first and second hydraulic pumps 20 and 30 may operate with power generated by a separate motor or an engine of the forklift.

The tilt cylinder 100 may be rotatable relative to a body of the forklift to tilt the mast 10 forward (right direction in FIG. 1) or backward (left direction in FIG. 1). Also, the tilt cylinder 100 may include a piston 103 that partitions an inside space of the tilt cylinder 100 into a compression chamber 101 and a tensile chamber 102, and a piston rod of which one end is fixed to the piston 103 and another end is rotatably coupled to the mast 10. During a compression stroke of the tilt cylinder 100, the piston 103 may slide toward the tensile chamber 102, and during a tension stroke of the tilt cylinder 100, the piston 103 may slide toward the compression chamber 101. More specifically, while the tilt cylinder 100 performs a compression stroke and rotates in one direction (counterclockwise direction in FIG. 1), the mast 10 may be tilted backward, and while the tilt cylinder 100 performs a tension stroke and rotates in another direction (clockwise direction in FIG. 1), the mast 10 may be tilted forward. That is, a tilt operation of the mast 10 may be linked with a stroke and rotation operation of the tilt cylinder 100.

Meanwhile, a tilt angle θ of the mast 10 may be defined as an angle between the mast 10 and a reference position (θ=0) of the mast 10 as shown in FIG. 1. When the mast 10 is tilted backward as shown in FIG. 2, a tilt angle θ of the mast 10 may satisfy equation ‘θ<0’, and, when the mast 10 is tilted forward as shown in FIG. 4, a tilt angle θ of the mast 10 may satisfy equation ‘θ>0’.

The direction control valve 200 may control a tilt direction of the mast 10. To this end, the direction control valve 200 may include a main housing (reference numeral is omitted) in which a plurality of ports is formed, and a main spool (reference numeral is omitted) that controls a transfer direction of the working fluid through the main hydraulic line ML.

For example, the plurality of ports may include a hydraulic port P that is connected to the first hydraulic pump 20 and receives the working fluid, a tank port T that is connected to an oil tank 50 and discharges the working fluid, a first main port B that is connected to the compression chamber 101 and through which the working fluid flows in or out, and a second main port A that is connected to the tensile chamber 102 and through which the working fluid flows in or out. In this case, the main fluid line ML may include a first main flow path ML1 that connects the first hydraulic pump 20 to the hydraulic port P, a 2-1 main flow path ML2-1 that connects the compression chamber 101 to the first main port B, a 2-2 main flow path ML2-2 that connects the tensile chamber 102 to the second main port A, and a third main flow path ML3 that connects the oil tank 50 to the tank port T.

The main spool may be slidingly movable inside a main housing and operate by hydraulic pressure of the control fluid. Also, the main spool may operate by a pressure difference between the control fluids applied to both ends (vertical direction in FIG. 1). When pressure of the control fluid applied to another side (upper side in FIG. 1) end of the main spool is greater than pressure of the control fluid applied to one side (lower side in FIG. 1) end of the main spool, the main spool may slide to the one side. Also, the main spool may include at least one connection flow path that connects the hydraulic port P to any one of the first main port B and the second main port A and connects the tank port T to another one of the first main port B and the second main port A. The connection path may be formed by penetrating the main spool or by being recessed from an outer surface of the main spool.

As shown in FIG. 2, when the main spool slides to the one side (lower direction in FIG. 2), the hydraulic port P may be connected to the first main port B, and the tank port T may be connected to the second main port A. In this case, the first hydraulic pump 20 may supply the working fluid to the compression chamber 101, and the working fluid may be discharged from the tensile chamber 102 to the oil tank 50. At this time, the hydraulic port P and the second main port A may be inlets through which the working fluid is supplied to the direction control valve 200, and the first main port B and the tank port T may be outlets through which the working fluid is discharged from the direction control valve 200. Also, the piston 103 may slide to the tensile chamber 102 by changes in volume and hydraulic pressure of the respective chambers, and accordingly, the tilt cylinder 100 may rotate in the counterclockwise direction and the mast 10 may be tilted backward.

As shown in FIG. 4, when the main spool slides to the other side (upper direction in FIG. 4), the hydraulic port P may be connected to the second main port A, and the tank port T may be connected to the first main port B. That is, the first hydraulic pump 20 may supply the working fluid to the tensile chamber 102, and the working fluid may be discharged from the compression chamber 101 to the oil tank 50. At this time, the hydraulic port P and the first main port B may be inlets through which the working fluid is supplied to the direction control valve 200, and the second main port A and the tank port T may be outlets through which the working fluid is discharged from the direction control valve 200. Also, the piston 103 may slide to the compression chamber 101 by changes in volume and hydraulic pressure of the respective chambers. Accordingly, the tilt cylinder 100 may rotate in the clockwise direction and the mast 10 may be tilted forward.

The remote control valve 40 may receive the working fluid pressed by the second hydraulic pump 30 through the pilot hydraulic line PL. Also, the remote control valve 40 may receive an operator's intention for tilting the mast 10 forward or backward, and selectively connect any one of one end (lower end in FIG. 1) and another end (upper end in FIG. 1) of the direction control valve 200 on the pilot hydraulic line PL to the second hydraulic pump 30 according to the received intention. Accordingly, the remote control valve 40 may control a direction in which the control fluid is supplied to the direction control valve 200 to control an operation direction of the direction control valve 200.

In this case, the pilot hydraulic line PL may be configured with a first pilot flow path PL1 between the second hydraulic pump 30 and the remote control valve 40, a 2-1 pilot flow path PL2-1 between the remote control valve 40 and the other side of the direction control valve 200, and a 2-2 pilot flow path PL2-2 between the remote control valve 40 and the one side of the direction control valve 200.

More specifically, the remote control valve 40 may selectively supply the working fluid pressed by the second hydraulic pump 30 to any one of one end (lower end in FIG. 1) and the other end (upper end in FIG. 1) of the main spool, thereby making a difference between pressure of the control fluid applied to any one of the one end and the other end of the main spool and pressure of the control fluid applied to the other one. Accordingly, the main spool may slide inside the main housing.

As shown in FIG. 2, when the remote control valve 40 receives an operator's intention for tilting the mast 10 backward, the remote control valve 40 may connect the first pilot flow path PL1 to the 2-1 pilot flow path PL2-1. In this case, the control fluid may be transferred along the pilot hydraulic line PL and apply pressure to the other end (upper end in FIG. 2) of the main spool to cause the main spool to slide to one side (lower side in FIG. 2). Accordingly, the connection flow path of the main spool may connect the hydraulic port P to the first main port B and connect the tank port T to the second main port A. Also, the control fluid at the one end (lower end in FIG. 2) of the main spool on the pilot hydraulic line PL may be retrieved in the oil tank 50 through the 2-2 pilot flow path PL2-2, and accordingly, the main spool may smoothly slide.

As shown in FIG. 4, when the remote control valve 40 receives an operator's intention for tilting the mast 10 forward, the remote control valve 40 may connect the first pilot flow path PL1 to the 2-2 pilot flow path PL2-2. In this case, the control fluid may be transferred along the pilot hydraulic line PL and apply pressure to the one end (lower end in FIG. 2) to cause the main spool to slide to the other side (upper side in FIG. 4). Accordingly, the connection flow path of the main spool may connect the hydraulic port P to the second main port A and connect the tank port T to the first main port B. Also, the control fluid at the other end (upper end in FIG. 4) of the main spool on the pilot hydraulic line PL may be retrieved in the oil tank 50 through the 2-1 pilot flow path PL2-1.

Meanwhile, the piston 103 may slide within a preset range inside the tilt cylinder 100, and the mast 10 may also be tilted forward or backward within a preset angle range.

Referring to FIG. 1, a tilt angle θ of the mast 10 when a compression stroke of the tilt cylinder 100 reaches an end may be defined as a minimum tilt angle θ_{MIN}. Also, a tilt angle θ of the mast 10 when a tension stroke of the tilt cylinder 100 reaches an end may be defined as a maximum tilt angle θ_{MAX}. That is, the mast 10 may be tilted within an angle range [θ_{MIN}, θ_{MAX}] between the minimum tilt angle θ_{MIN} and the maximum tilt angle θ_{MAX}.

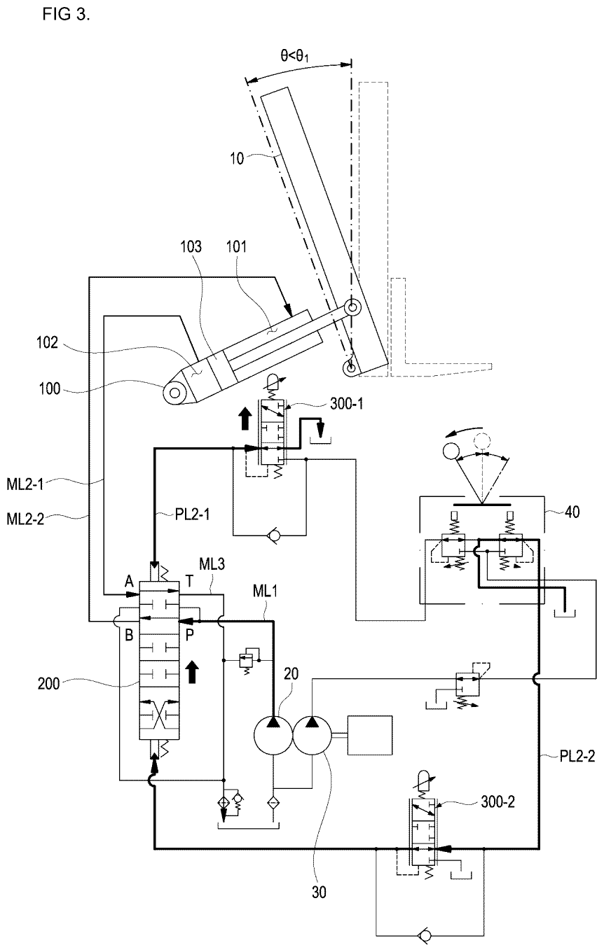

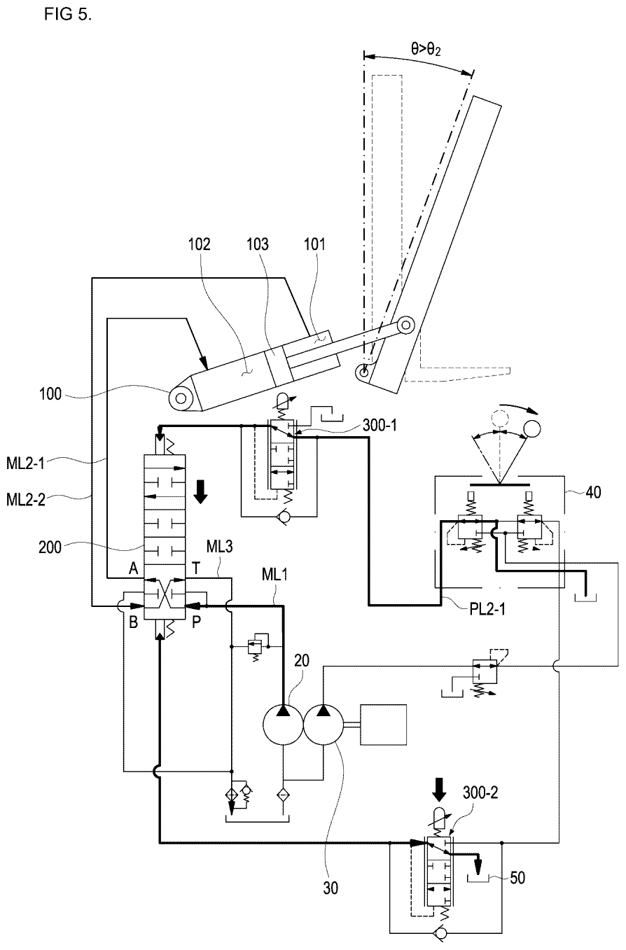

FIG. 3 is a circuit diagram showing a case in which a tilt angle of the mast 10 shown in FIG. 1 is less than the preset angle range while the mast 10 is tilted backward, and FIG. 5 is a circuit diagram showing a case in which a tilt angle of the mast 10 shown in FIG. 1 exceeds the preset angle range while the mast 10 is tilted forward.

Referring to FIGS. 1 to 5, the tilt control system of the forklift according to an embodiment may implement a cushion function of mitigating shock by decelerating the piston 103 when a stroke of the piston 103 approaches an end during a compression or tension stroke of the tilt cylinder 100. At this time, by reducing a flow rate of the working fluid that is supplied to the tilt cylinder 100, the piston 103 may be decelerated.

Because a compression or tension stroke of the tilt cylinder 100 is linked with a forward or backward tilt of the mast 10, cases in which a stroke of the piston 103 approaches an end may be defined as a case in which a tilt angle θ of the mast 10 tilted backward is less than a preset first angle θ₁ and a case in which a tilt angle θ of the mast 10 tilted forward exceeds a preset second angle θ₂.

Here, the first angle θ₁ and the second angle θ₂ may satisfy Equations ‘θ_{MIN}<θ₁<0’ and ‘0<θ₂<θ_{MAX}’. A tilt angle θ of the mast 10 may satisfy Equation ‘θ_{MIN}≤θ<θ₁’ when the tilt angle θ is less than the preset first angle θ₁, and may satisfy Equation ‘θ₂<θ≤θ_{MAX}’ when the tilt angle θ exceeds the preset second angle θ₂.

In other words, the case in which a stroke of the piston 103 approaches an end may be defined as a case in which a tilt angle θ of the mast 10 exceeds or is less than the present angle range [θ₁, θ₂].

Hereinafter, a method of implementing a cushion function by the pressure reducing valve 300 will be described.

The pressure reducing valve 300 may be positioned between the direction control valve 200 and the remote control valve 40 on the pilot hydraulic line PL. Also, the pressure reducing valve 300 may reduce pressure of the control fluid at a rear end of the pressure reducing valve 300 on the pilot hydraulic line PL1 when a tilt angle θ of the mast 10 exceeds or is less than the preset angle range [θ₁, θ₂].

Also, a plurality of pressure reducing valves 300 may be provided. For example, the plurality of pressure reducing valves 300 may include a first pressure reducing valve 300-1 provided between the other end (upper end in the drawing) of the direction control valve 200 and the remote control valve 40 on the 2-1 pilot flow path PL2-1, and a second pressure reducing valve 300-2 provided between one end (lower end in the drawing) of the direction control valve 200 and the remote control valve 40 on the 2-2 pilot flow path PL2-2. In this case, the rear end of the pressure reducing valve 300 on the pilot hydraulic line PL may include a rear end of the first pressure reducing valve 300-1 on the 2-1 pilot flow path PL2-1, and a rear end of the second pressure reducing valve 300-2 on the 2-2 pilot flow path PL2-2. More specifically, the rear end of the pressure reducing valve 300 on the pilot hydraulic line PL may be the rear end of the first pressure reducing valve 300-1 on the 2-1 pilot flow path PL2-1 when the mast 10 is tilted backward, as shown in FIGS. 2 and 3, and, when the mast 10 is tilted forward, the rear end of the pressure reducing valve 300 on the pilot hydraulic line PL may be the rear end of the second pressure reducing valve 300-2 on the 2-2 pilot flow path PL2-2, as shown in FIGS. 4 and 5.

Here, that pressure of the control fluid at the rear end of the pressure reducing valve 300 is reduced may mean that pressure of the control fluid at the rear end of the pressure reducing valve 300 when a tilt angle θ of the mast 10 exceeds or is less than the preset angle range [θ₁, θ₂] is smaller than when a tilt angle θ of the mast 10 belongs to the preset angle range [θ₁, θ₂].

Referring to FIGS. 2 and 3, when the mast 10 is tilted backward and a tilt angle θ of the mast 10 is less than the preset angle range [θ₁, θ₂], the first pressure reducing valve 300-1 may reduce pressure of the control fluid at the rear end of the first pressure reducing valve 300-1 on the 2-1 pilot flow path PL2-1.

For example, when the mast 10 is tilted backward within the preset angle range [θ₁, θ₂] (in this case, the connection flow path of the main spool connects the hydraulic port P to the first main port B and connects the tank port T to the second main port A), the first pressure reducing valve 300-1 may connect the other end (upper end in the drawing) of the direction control valve 200 to the second hydraulic pump 30. In this case, pressure of the control fluid on the 2-1 pilot flow path PL2-1 may be increased by the second hydraulic pump 30. Accordingly, due to an increase in pressure of the control fluid applied to the other end of the main spool, the main spool may slide to the one side (lower side in the drawing). Also, the main spool may be in a state of equilibrium with forces applied to both ends. Here, a force applied to the other end of the main spool may include a force generated by the control fluid, and a force applied to the one end of the main spool (the upper end in the drawing) may include a force generated by the control fluid, a vertical force on the main housing, a restoring force generated by a spring, and other forces.

Thereafter, when the mast 10 is further tilted backward and a tilt angle θ of the mast 10 is less than the preset angle range [θ₁, θ₂], the first pressure reducing valve 300-1 may connect the other end of the direction control valve 200 to the oil tank 50. That is, the rear end of the first pressure reducing valve 300-1 on the 2-1 pilot flow path PL2-1 may be connected to the oil tank 50. Accordingly, pressure of the control fluid at the rear end of the first pressure reducing valve 300-1 on the 2-1 pilot flow path PL2-1 may be equal or similar to pressure of the control fluid accommodated in the oil tank 50. Here, because the pressure of the control fluid accommodated in the oil tank 50 is lower than pressure of the control fluid pressed by the second hydraulic pump 30, the pressure of the control fluid at the rear end of the first pressure reducing valve 300-1 on the 2-1 pilot oil path PL2-1 may be reduced. In this way, when the mast 10 is tilted backward and a tilt angle θ of the mast 10 is less than the preset angle range [θ₁, θ₂], the first pressure reducing valve 300-1 may reduce pressure of the control fluid at the rear end of the first pressure reducing valve 300-1 on the 2-1 pilot flow path PL2-1.

Accordingly, the pressure of the control fluid applied to the other end of the main spool and a force caused by the pressure of the control fluid may be reduced, and the main spool may slide to the other side (upper side in the drawing) by a force applied to the one end of the main spool. Nevertheless, the connection flow path of the main spool may connect the hydraulic port P to the first main port B and connect the tank port T to the second main port A. However, an opening area of the connection flow path facing at least one of the hydraulic port P, the tank port T, the first main port B, and the second main port A may be reduced. In addition, the reduction in the opening area may cause an increase in flow resistance and pressure loss, and a flow rate of the working fluid transported along the main hydraulic line ML may be reduced, which may decelerate the piston 103.

Referring to FIGS. 4 and 5, when the mast 10 is tilted forward and a tilt angle θ of the mast 10 exceeds the preset angle range [θ₁, θ₂], the second pressure reducing valve 300-2 may reduce pressure of the control fluid at the rear end of the second pressure reducing valve 300-2 on the 2-2 pilot flow path PL2-2.

For example, when the mast 10 is tilted forward within the preset angle range [θ₁, θ₂] (in this case, the connection flow path of the main spool connects the hydraulic port P to the second main port A and connects the tank port T to the first main port B), the second pressure reducing valve 300-2 may connect one end (lower end in the drawing) of the direction control valve 200 to the second hydraulic pump 30. In this case, pressure of the control fluid on the 2-2 pilot flow path PL2-2 may be increased by the second hydraulic pump 30. Accordingly, due to an increase in pressure of the control fluid applied to the one end of the main spool, the main spool may slide to the other side (upper side in the drawing). Also, the main spool may be in a state of equilibrium with forces applied to both ends. Here, a force applied to the main spool has been described above.

Thereafter, when the mast 10 is further tilted forward and a tilt angle θ of the mast 10 exceeds the preset angle range [θ₁, θ₂], the second pressure reducing valve 300-2 may connect the one end of the direction control valve 200 to the oil tank 50. That is, the rear end of the second pressure reducing valve 300-2 on the 2-2 pilot flow path PL2-2 may be connected to the oil tank 50. Accordingly, pressure of the control fluid at the rear end of the second pressure reducing valve 300-2 on the 2-2 pilot flow path PL2-2 may be equal or similar to pressure of the oil tank 50. Accordingly, when the mast 10 is tilted forward and a tilt angle θ of the mast 10 exceeds the preset angle range [θ₁, θ₂], the second pressure reducing valve 300-2 may reduce pressure of the control fluid at the rear end of the second pressure reducing valve 300-2 on the 2-2 pilot flow path PL2-2.

Because a force applied to the one end of the main spool is reduced, the main spool may slidingly operate to the one side (lower side in the drawing) by a force applied to the other end of the main spool. Nevertheless, the connection flow path of the main spool may connect the hydraulic port P to the second main port A and connect the tank port T to the first main port B. However, an opening area of the connection flow path facing at least one of the hydraulic port P, the tank port T, the first main port B, and the second main port A may be reduced. Accordingly, a flow rate of the working fluid transported along the main hydraulic line ML may be reduced, which may decelerate the piston 103.

Accordingly, when a tilt angle θ of the mast 10 exceeds or is less than the preset angle range [θ₁, θ₂], the pressure reducing valve 300 may reduce pressure of the control fluid at the rear end of the pressure reducing valve 300 on the pilot hydraulic line PL.

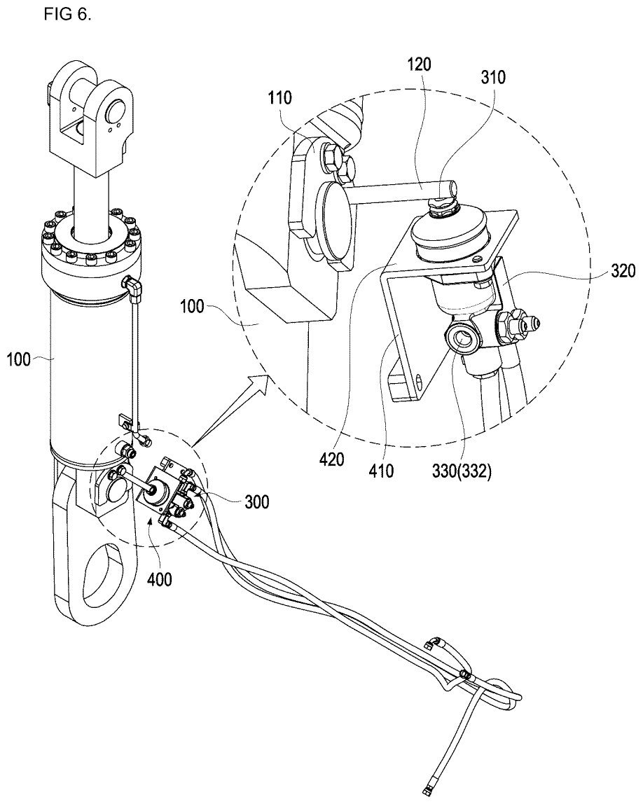

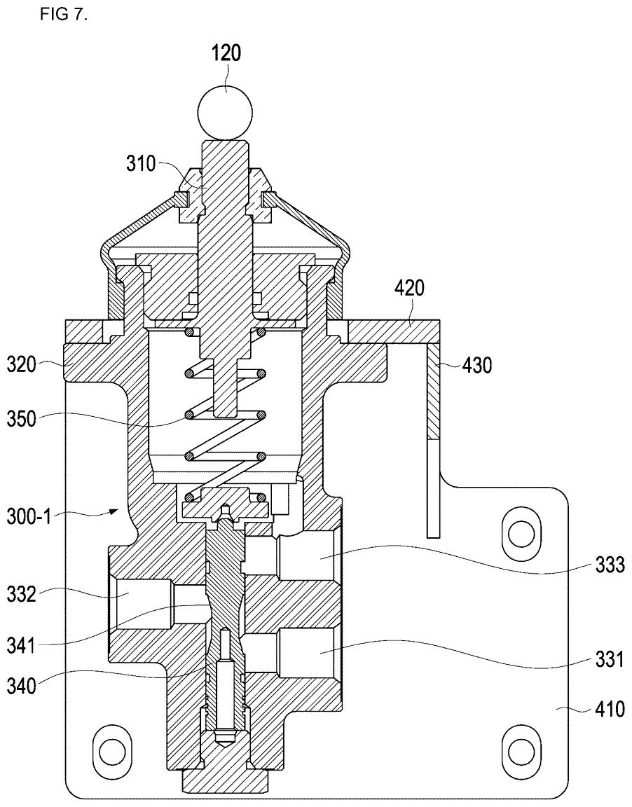

FIG. 6 is a perspective view and an enlarged view showing a main part of the tilt control system of the forklift according to an embodiment, and FIG. 7 is a cross-sectional view showing the first pressure reducing valve 300-1 which is a main part of the tilt control system of the forklift according to an embodiment.

Referring to FIGS. 1, 6, and 7, the tilt control system of the forklift may further include a mounting plate 110 coupled to the tilt cylinder 100 and rotating together with the tilt cylinder 100, and a pressing member 120 extending parallel to a rotation axis of the tilt cylinder 100 and coupled to the mounting plate 110 at one side.

Also, the pressure reducing valve 300 may include a pilot housing 320 of a hollow type, a push rod 310 inserted into the pilot housing 320 and configured to be displaced when one end (upper end in FIG. 7) is pressed or released by the tilt cylinder 100, a pilot spool 340 having one end (upper end in FIG. 7) connected to another end (lower end in FIG. 7) of the push rod 310 and configured to be slidable inside the pilot housing 320, and an elastic member 350 having one end (upper side in FIG. 7) connected to the push rod 310 and another end (lower side in FIG. 7) connected to the pilot spool 340.

Also, the tilt control system of the forklift may further include a mounting bracket 400 having one side coupled to the body of the forklift, wherein the pilot housing 320 is mounted on another side of the mounting bracket 400. The mounting bracket 400 may be positioned adjacent to the tilt cylinder 100 such that the pressing member 120 presses the push rod 310 according to a rotation of the tilt cylinder 100.

The mounting plate 110 may have a plate shape and be coupled to the tilt cylinder 100 by a coupling screw (reference numeral is omitted) to rotate together with the tilt cylinder 100. For example, the mounting plate 110 may be adjacent to the rotation axis of the tilt cylinder 100. Also, the mounting plate 110 may include a coupling portion (not shown) formed by penetrating the mounting plate 110 or being recessed from the mounting plate 110, and one side of the pressing member 120 may be inserted in the coupling portion. In an inner surface of the coupling portion and an outer surface of the pressing member 120, screw threads may be formed for screw coupling. Alternatively, press-fit coupling may also be possible. However, the disclosure is not limited thereto, and other known methods for stably fixing the pressing member 120 to the mounting plate 110 may be used.

The pressing member 120 may extend parallel to the rotation axis of the tilt cylinder 100, and one side of the pressing member 120 may be positioned on the tilt cylinder 100 to rotate together with the tilt cylinder 100. For example, the pressing member 120 may be connected and fixed to the tilt cylinder 100 by one side inserted in a coupling portion of the mounting plate 110. In this case, the pressing member 120 may be arranged with a central axis that is eccentric with the rotation axis of the tilt cylinder 100, and while the tilt cylinder 100 rotates, the pressing member 120 may move along an arc-shaped path. That is, the pressing member 120 may rotate around the rotation axis of the tilt cylinder 100. Meanwhile, one end of the push rod 310 may be arranged on the arc-shaped path of the pressing member 120. Accordingly, when the tilt cylinder 100 rotates in another direction (clockwise direction in FIG. 1), another side of the pressing member 120 may press the push rod 310, and when the tilt cylinder 100 rotates in one direction (counterclockwise direction in FIG. 1), the pressed state of the push rod 310 may be released. The pressing member 120 may have an appropriate length to press the push rod 310.

One end of the push rod 310 may be pressed or released by a rotation of the tilt cylinder 100 in one direction or another direction, and accordingly, the push rod 310 may move inward or outward relative to (be inserted into or withdrawn from) the pilot housing 320. For example, when the tilt cylinder 100 rotates in the other direction to press the push rod 310, the elastic member 350 may be compressed and the push rod 310 may be move inward relative to the pilot housing 320. Also, when the tilt cylinder 100 rotates in the one direction and the pressed state of the push rod 310 is released, the push rod 310 may be move outward relative to the pilot housing 320 by a restoring force of the elastic member 350. At this time, the push rod 310 may be pressed or released by the pressing member 120 which will be described below.

The pilot housing 320 may be a hollow type to accommodate at least a part of the push rod 310, the elastic member 350, and the pilot spool 340 therein. Also, a plurality of ports 330 may be formed in the pilot housing 320. The plurality of ports 330 may include a first pilot port 331 that is connected to the second hydraulic pump 30 and receives the control fluid, a second pilot port 332 that is connected to the direction control valve 200 and discharges or receives a control fluid, and a third pilot port 333 that is connected to the oil tank 50.

The elastic member 350 may transfer a displacement of the push rod 310, that is, a vertical motion by the inward or outward movement (insertion or withdrawal) of the push rod 310, to the pilot spool 340 to cause the pilot spool 340 to slide. Also, a transferred displacement amount may be reduced due to characteristics of a spring. For example, the elastic member 350 may be a spring.

The pilot spool 340 may be connected to another end of the push rod 310 through the elastic member 350 to be slidable inside the pilot housing 320. Meanwhile, although not shown in the drawings, a rebound spring may be provided between the pilot spool 340 and the pilot housing 320. Accordingly, when the push rod 310 moves inward relative to the pilot housing 320, the elastic member 350 may be compressed to apply an elastic force to the pilot spool 340, and the pilot spool 340 may slide to the other side (lower side in FIG. 7) by compression of the rebound spring. In contrast, when the push rod 310 moves outward relative to the pilot housing 320, the pilot spool 340 may slide to one side (upper side in FIG. 7) by a restoring force of the rebound spring.

Also, the pilot spool 340 may include a groove 341 formed by being recessed from the outer surface and include a first position and a second position. At the first position, the pilot spool 340 may connect the first pilot port 331 to the second pilot port 332 through the groove 341. In contrast, at the second position, the pilot spool 340 may connect the second pilot port 332 to the third pilot port 333 through the groove 341. In this way, the pilot spool 340 may selectively connect the second pilot port 332 to any one of the first pilot port 331 and the third pilot port 333.

Referring to FIGS. 1 to 3, 6, and 7, when a tilt angle θ of the mast 10 belongs to the preset angle range [θ₁, θ₂], the pilot spool 340 of the first pressure reducing valve 300-1 may be located at the first position. Also, when a tilt angle θ of the mast 10 is less than the preset angle range [θ₁, θ₂], the pilot spool 340 of the first pressure reducing valve 300-1 may be located at the second position.

When the mast 10 is located at the reference position (θ=0), as shown in FIG. 1, the pressing member 120 may press the push rod 310, as shown in FIG. 7, and the pilot spool 340 may connect the first pilot flow path PL1 to a second pilot flow path.

Also, when the tilt cylinder 100 rotates in one direction (counterclockwise direction in the drawings) such that the mast 10 is tilted backward, the pressing member 120 may move upward to gradually release the pressed state of the push rod 310 (see FIG. 7). Also, the pilot spool 340 may slide upward by the restoring force of the rebound spring (see FIG. 7).

More specifically, when a tilt angle θ of the mast 10 exceeds the preset first angle θ₁, as shown in FIG. 2, the pilot spool 340 may connect the first pilot port 331 to the second pilot port 332 at the first position. Thereafter, when the tilt angle θ of the mast 10 becomes equal to the preset first angle θ₁, the pilot spool 340 may slide upward to block flow of the control fluid between the first pilot port 331 and the second pilot port 332. Finally, when a tilting angle θ of the mast 10 is less than the preset first angle θ₁, the pilot spool 340 may further slide upward to change to the second position, and connect the second pilot port 332 to the third pilot port 333.

Here, a displacement amount of the push rod 310 at which the pilot spool 340 of the first pressure reducing valve 300-1 changes from the first position to the second position when a tilt angle θ of the mast 10 is less than the preset first angle θ₁ may be defined as a ‘preset first distance’.

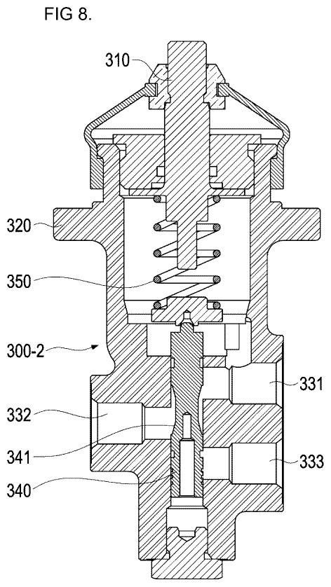

FIG. 8 is a cross-sectional view showing the second pressure reducing valve 300-2 of the tilt control system of the forklift according to an embodiment.

Referring to FIGS. 1, 4 to 7, and 8, the second pressure reducing valve 300-2 may have a different arrangement of the plurality of ports 330 compared to the first pressure reducing valve 300-1. When the tilt cylinder 100 rotates in the other direction (clockwise direction in the drawings) and a tilt angle θ of the mast 10 exceeds the preset second angle θ₂, the second pressure reducing valve 300-2 may reduce pressure of the control fluid. For example, when the tilt cylinder 100 rotates in the other direction, the pressing member 120 may gradually press the push rod 310, and therefore, the pilot spool 340 may slide downward (see FIG. 8). Accordingly, the second pressure reducing valve 300-2 may have a different arrangement of the first pilot port 331 and the third pilot port 333 compared to the first pressure reducing valve 300-1, as shown in FIG. 8.

When a tilt angle θ of the mast 10 belongs to the preset angle range [θ₁, θ₂], the pilot spool 340 of the second pressure reducing valve 300-2 may be located at the first position to connect the first pilot port 331 to the second pilot port 332. When a tilt angle θ of the mast 10 exceeds the preset angle range [θ₁, θ₂], the pilot spool 340 of the second pressure reducing valve 300-2 may be located at the second position to connect the second pilot port 332 to the second pilot port 332.

More specifically, when the mast 10 is located at the reference position (θ=0), as shown in FIG. 1, the pilot spool 340 may connect the first pilot flow path PL1 to the second pilot flow path. At this time, the pressing member 120 may be in a state of pressing the push rod 310 or a state of releasing the push rod 310.

Also, when the tilt cylinder 100 rotates in the clockwise direction such that the mast 10 is tilted forward, the pressing member 120 may press the push rod 310. Accordingly, the pilot spool 340 may slide downward (see FIG. 8).

More specifically, when a tilt angle θ of the mast 10 is less than the preset second angle θ₂, as shown in FIG. 2, the pilot spool 340 may connect the first pilot pot 331 to the second pilot ort 332 at the first position. Thereafter, when a tilt angle θ of the mast 10 becomes equal to the preset second angle θ₂, the pilot spool 340 may slide downward to block flow of the control fluid between the first pilot port 331 and the second pilot port 332. Finally, when a tilt angle θ of the mast 10 exceeds the preset second angle θ₂, the pilot spool 340 may further slide downward to change to the second position, and connect the second pilot port 332 to the third pilot port 333.

However, the disclosure is not limited thereto. When the tilt cylinder 100 rotates in one direction (counterclockwise direction in the drawings), the second pressure reducing valve 300-2 may cause the pressing member 120 to press the push rod 310, and, when the tilt cylinder 100 rotates in another direction (clockwise direction in the drawings), the second pressure reducing valve 300-2 may cause the pressing member 120 to release the push rod 310. For example, unlike FIG. 6, when the pressing member 120 moves symmetrically to the rotation axis of the tilt cylinder 100 and the push rod 310 of the second pressure reducing valve 300-2 is located on a path of the pressing member 120 moved symmetrically, the pressing member 120 may press the push rod 310 when the tilt cylinder 100 rotates in one direction and may release the push rod 310 when the tilt cylinder 100 rotates in the other direction. In this case, the plurality of ports 330 of the second pressure reducing valve 330 may have the same arrangement as the plurality of ports 330 of the first pressure reducing valve 300-1, and the above-described content may be applied to the first pressure reducing valve 300-1 by reversing the rotation directions of the tilt cylinder 100.

Meanwhile, a displacement amount of the push rod 310 at which the pilot spool 340 of the first pressure reducing valve 300-1 changes from the first position to the second position when a tilt angle θ of the mast 10 exceeds the preset second angle θ₂ may be defined as a ‘preset second distance’.

Accordingly, when a tilt angle θ of the mast 10 belongs to the preset angle range [θ₁, θ₂], the pilot spool 340 of the pressure reducing valve 300 may be located at the first position, and, when a tilt angle θ of the mast 10 exceeds or is less than the preset angle range [θ₁, θ₂] and the push rod 310 is displaced by a preset distance, the pilot spool 340 may slide and be located at the second position.

Meanwhile, the mounting bracket 400 may include a vertical plate 410 mounted on the body, and a reinforcing rib 430 for securing rigidity.

The vertical plate 410 may be mounted adjacent to the tilt cylinder 100 on the body. Accordingly, an increase in length of the pressing member 120 may be suppressed.

The horizontal plate 420 may be parallel to the pressing member 120, and an opening may penetrate the horizontal plate 420. The pressure reducing valve 300 may be inserted in the opening, and the pilot housing 320 may be mounted on the horizontal plate 420 by a method such as screw coupling, etc.

The reinforcing rib 430 may be provided between the horizontal plate 420 and the vertical plate 410. The pressing member 120 may press the horizontal plate 420 through the pressure reducing valve 300, while preventing bending of the mounting bracket 400 through the reinforcing rib 430. Accordingly, the pressure reducing valve 300 may maintain an initial position and ensure operational reliability.

To improve operational reliability of the cushion function, the pressing member 120 may be coupled to the push rod 310. More specifically, the pressing member 120 may rotate in one direction to move the push rod 310 outward relative to the pilot housing 320, or the pressing member 120 may rotate in another direction to move the push rod 310 inward relative to the pilot housing 320. By linking a displacement of the push rod 310 with a tilt of the mast 10 and a rotation of the tilt cylinder 100, operational reliability may be ensured.

At this time, the pressing member 120 may move along an arc-shaped path according to a rotation of the tilt cylinder 100, that is, the pressing member 120 may rotate, while the push rod 310 may be displaced along a straight path when moving inward or outward relative to the pilot housing 320. Accordingly, the pressing member 120 may be coupled to the tilt cylinder 100 such that motion conditions of the pressing member 120 and the tilt cylinder 100 are satisfied.

To this end, the tilt control system of the forklift according to an embodiment may further include a motion converting mechanism 130 that couples the pressing member 120 with the push rod 310 and converts a rotational motion of the pressing member 120 into a linear motion of the push rod 310.

For example, the motion converting mechanism 130 may be a connecting rod (not shown) having one end connected to the pressing member 120 and another end connected to the push rod 310, and may couple the pressing member 120 to the push rod 310 through a crank-slider mechanism. The crank-slider mechanism is a widely used technique, and therefore, a detailed description thereof will be omitted.

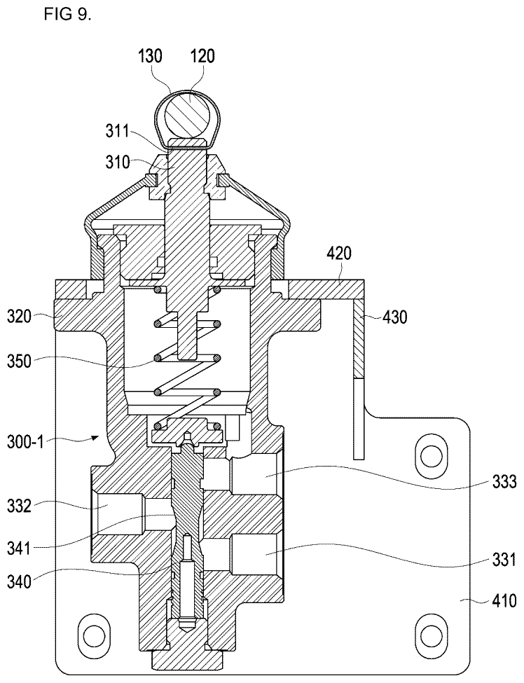

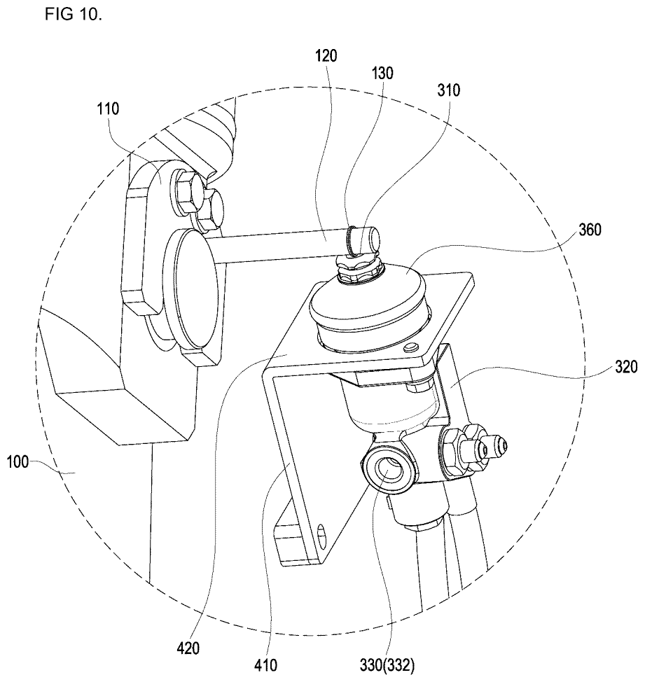

FIG. 9 is a cross-sectional view of a main part of the tilt control system of the forklift according to an embodiment, additionally showing the motion converting mechanism 130, and FIG. 10 is an enlarged perspective view of a main part of the tilt control system of the forklift according to an embodiment, additionally showing the motion converting mechanism 130.

Referring to FIGS. 9 and 10, the motion converting mechanism 130 may be a coupling ring having an elliptical ring shape. The coupling ring may be coupled to one end of the push rod 310, and the pressing member 120 may be inserted in the coupling ring. A coupling hole 311 may be formed at one end of the push rod 310 by penetrating the push rod 310 or being recessed from the push rod 310 such that the coupling ring is installed at the one end of the push rod 310.

A width in left-right direction of the coupling ring may be greater than a height in up-down direction of the coupling ring, as shown in FIG. 9. The reason may be to allow a movement in left-right direction of the pressing member 120 along the arc-shaped path of the pressing member 120 inside the coupling ring.

Accordingly, the pressing member 120 may press the push rod 310 to one side (upper side in FIG. 9) through the motion converting mechanism 130 to move the push rod 310 outward relative to the pilot housing 320. Also, the pressing member 120 may press the push rod 310 to another side (lower side in FIG. 9) to move the push rod 310 inward relative to the pilot housing 320. As such, because the push rod 310 is coupled to the pressing member 120, a displacement of the push rod 310 may be linked with a rotation of the tilt cylinder 100 and a tilt angle θ of the mast 10, thereby ensuring operational reliability of the cushion function.

Because the tilt control system of the forklift according to an embodiment implements the cushion function of the tilt cylinder 100, that is, deceleration of the piston 103 through a mechanical connection between the tilt cylinder 100 and the pressure reducing valve 300, the cushion function may be generated simultaneously in the plurality of tilt cylinders 100 and operations of the plurality of tilt cylinders 100 may be easily synchronized.

In addition, because a separate shock absorbing device as in the conventional technique is omitted and a cushion function is implemented through the pressure reducing valve 300 on the hydraulic line, product durability may be improved. In addition, by adjusting an operating point at which the pilot spool 340 changes from the first position to the second position by pressing the push rod 310, for example, by adjusting a position of the pressure reducing valve 300 on the mounting bracket 400, an operating range of the piston 103 on the tilt cylinder 100 may be easily limited.

The tilt control system of the forklift according to an embodiment may decelerate an operation of the tilt cylinder when the operation of the tilt cylinder reaches an end by linking the operation of the tilt cylinder with the pressure reducing valve of the pilot hydraulic circuit, thereby mitigating shock and reducing an operator's working fatigue.

The tilt control system of the forklift according to an embodiment may reduce system costs and improve durability through a simple structure using the pressure reducing valve.

The tilt control system of the forklift according to an embodiment may limit an operating range of the tilt cylinder by adjusting an operating point of the pressure reducing valve without adding another component to the tilt cylinder.

The tilt control system of the forklift according to an embodiment may easily synchronize operations of the plurality of tilt cylinders.

What is claimed is:

1. A tilt control system of a forklift comprising:
a main hydraulic line including a tilt cylinder configured to tilt a mast forward or backward, a first hydraulic pump configured to supply a working fluid to the tilt cylinder, and a direction control valve configured to control a tilt direction of the mast; and
a pilot hydraulic line including a second hydraulic pump configured to supply a control fluid, a remote control valve connected to the direction control valve and configured to control the direction control valve, and a pressure reducing valve provided between the direction control valve and the remote control valve,
wherein the pressure reducing valve includes a push rod configured to be displaced by one end being pressed or released by the tilt cylinder, the pressure reducing valve configured to reduce pressure of the control fluid at a rear end of the pressure reducing valve on the pilot hydraulic line according to a displacement of the push rod when a tilt angle of the mast exceeds or is less than a preset angle range.

2. The tilt control system of the forklift of claim 1, wherein the direction control valve includes an inlet through which the working fluid is supplied to the direction control valve, an outlet through which the working fluid is discharged from the direction control valve, a main spool configured to operate by hydraulic pressure of the control fluid, and a flow path connecting the inlet to the outlet.

3. The tilt control system of the forklift of claim 2, wherein the direction control valve is configured to reduce an opening area of the flow path facing at least one of the inlet and the outlet when the pressure of the control fluid at the rear end of the pressure reducing valve on the pilot hydraulic line is reduced.

4. The tilt control system of the forklift of claim 1, wherein the pressure reducing valve includes a housing being a hollow type and including a plurality of ports, and a pilot spool of which one side is connected to another end of the push rod, the pilot spool configured to be slidable inside the housing.

5. The tilt control system of the forklift of claim 4, wherein the plurality of ports includes a first port configured to receive the control fluid from the second hydraulic pump, a second port configured to discharge the control fluid to the direction control valve, and a third port connected to an oil tank.

6. The tilt control system of the forklift of claim 5, wherein the pilot spool connects the first port to the second port at a first position and connects the second port to the third port at a second position.

7. The tilt control system of the forklift of claim 6, wherein, when a tilt angle of the mast belongs to the preset angle range, the pilot spool is located at the first position, and when a tilt angle of the mast exceeds or is less than the preset angle range and the push rod is displaced by a preset distance, the pilot spool slides and is located at the second position.

8. The tilt control system of the forklift of claim 5, wherein the pilot spool is in a cylinder shape and includes a groove recessed from an outer surface of the pilot spool, the groove being configured to selectively connect the second port to one of the first port and the third port.

9. The tilt control system of the forklift of claim 4, wherein
the push rod, the other end of which is inserted into the housing, is configured move inward or outward relative to the housing, and
the pressure reducing valve includes an elastic member, one side of which is connected to the push rod and the other side is connected to the pilot spool.

10. The tilt control system of the forklift of claim 4, further comprising a mounting bracket of which one side is coupled to a body of the forklift, wherein the housing is mounted on another side of the mounting bracket.

11. The tilt control system of the forklift of claim 1, wherein
the tilt cylinder is rotatable relative to the body on a rotation axis of one side,
the tilt cylinder further including
a pressing member extending parallel to the rotation axis, wherein one side of the pressing member is provided in the tilt cylinder to rotate together with the tilt cylinder, and another side of the pressing member is configured to press the push rod according to a rotation of the tilt cylinder.

12. The tilt control system of the forklift of claim 11, further comprising a motion converting mechanism configured to couple the pressing member to the push rod and convert a rotational motion of the pressing member into a linear motion of the push rod.
